(19) United States
(12) Patent Application Publication
(10) Pub. No.: US 2001/0047607 A1
(43) Pub. Date: Dec. 6, 2001

(54) Utility strap for fishing equipment

(76) Inventor: Daniel Harvanek, Littleton, CO (US)

Correspondence Address: DORSEY & WHITNEY, LLP, SUITE 4700, 370 SEVENTEENTH STREET, DENVER, CO, 80202-5647, US

(21) Appl. No.: 09/742,921

(22) Filed: Dec. 20, 2000

Related U.S. Application Data
(60) Provisional application No. 60/171,767, filed on Dec. 22, 1999.
(60) Provisional application No. 60/230,502, filed on Sep. 6, 2000.

(51) Int. Cl. A01K 97/10

(52) U.S. Cl. 43/21.2

(57) ABSTRACT

A utility strap for fishing equipment or accessory items is disclosed in two embodiments with both embodiments including a quick-release type fastener adapted to be secured to a fisherman's clothing at any location, a flexible strip having at least one part of a hook and loop type fastener and supporting a rigid loop from which other articles of fishing equipment or accessory items can be suspended. The hook and loop type material is secured along the length of the strip and can be utilized to releasably connect the strip to another article of fishing equipment having a second part of the hook and loop material secured thereto or in one embodiment of the invention, the utility strap has two component parts, each having one part of a hook and loop type fastener thereon so they can receive therebetween an article of fishing equipment to suspend the same from the fisherman's clothing.

### CROSS-REFERENCE TO RELATED APPLICATIONS

This application claims the benefit of U.S. provisional application No. 60/171,767, filed Dec. 22, 1999, entitled Anglers' Hands, and U.S. provisional application No. 60/230,502, filed Sep. 6, 2000, entitled Sticky Fly-Box. Each of these applications is hereby incorporated by reference as if fully disclosed herein.

### BACKGROUND OF THE INVENTION

1. Field of the Invention

The present invention relates generally to systems for supporting articles of fishing equipment, and more particularly to a utility strap that is quickly and releasably securable to an article of clothing and having releasable fasteners for supporting various articles of fishing equipment.

2. Description of the Relevant Art

Fishing is a sport that requires an unusual amount of equipment and ancillary items, and in addition, normally requires both hands. As a consequence, various types of fishing gear have been developed for accommodating the articles of equipment necessary for fishing including fishing poles, containers for lures, flies, anchors and the like. Some specially designed articles of clothing include an unusual number of pockets to accommodate such items or equipment for fishing, but many times such articles of clothing are in the form of relatively heavy jackets, which are cumbersome, and many times too heavy for relatively warm weather.

While devices have been devised for supporting a fishing pole on one's waist, the devices have typically been fairly complex as is evidenced by U.S. Pat. No. 5,813,162 issued to Tse et al. Similarly, other fishing pole supporting devices have been devised for hands-free use such as of a type that might be affixed to rigid members such as wheelchairs with an example of such being disclosed in U.S. Pat. No. 5,560,137 issued to Herring. The devices known in the prior art for supporting fishing poles and other ancillary fishing equipment have to date been somewhat cumbersome, difficult to operate, or formed as an integral part of an article of clothing and therefore suffer from numerous shortcomings making them less than satisfactory from a utilitarian standpoint.

Accordingly, a simple and convenient device for supporting and carrying numerous and various articles of fishing equipment in a simple easy to deploy manner would be desirable for the sport of fishing.

### SUMMARY OF THE INVENTION

The present invention relates to a utility strap that can be quickly, easily and releasably clamped to an article of clothing with the strap including systems built therein for supporting numerous articles of fishing equipment.

The utility strap has an elongated flexible strip of material having at least one part of a hook and loop type fastener secured thereto and a quick-release connector for releasably connecting the strap to an article of clothing. The one part of hook and loop fastener material can be used to secure the strap to an article of fishing equipment having the other part of the hook and loop fastener, or the strip of material can have both parts of the hook and loop type fastener material so that it can be secured to itself to form a closed loop from which articles of fishing equipment can be suspended.

In the preferred embodiment, the quick-release connector is in the form of an alligator clip that can be quickly and securely connected to any part of an article of clothing such as a T-shirt, fishing shirt, fishing jacket, trousers, or the like. The flexible strip of material preferably has a rigid loop secured to one end thereof opposite the quick-release connector so that other releasable connectors and/or articles of fishing equipment can be suspended therefrom.

Other aspects, features, and details of the present invention can be more completely understood by reference to the following detailed description of a preferred embodiment taken in conjunction with the drawings and from the appended claims.

### BRIEF DESCRIPTION OF THE DRAWINGS

FIG. 1 is an isometric view of a first embodiment of the utility strap of the present invention in a secured position.

FIG. 2 is an isometric view similar to FIG. 1 with the utility strap in an open position.

FIG. 3 is an isometric view of a fisherman utilizing a pair of the utility straps shown in FIG. 1 for supporting a fishing pole.

FIG. 4 is a fragmentary isometric view showing the utility strap of FIG. 1 secured at one end to an article of clothing and supporting a fishing pole while in the closed position of FIG. 1.

FIG. 5 is an isometric view of a fisherman utilizing a second embodiment of the present invention.

FIG. 6 is a fragmentary isometric view of the utility strap of FIG. 5 supporting a plurality of articles of fishing equipment.

FIG. 7 is a partially exploded isometric view of the strap of FIGS. 5 and 6 that are illustrating the use of the strap in supporting various articles of fishing equipment.

FIG. 8 is an isometric view of an open container for releasable attachment to the strap of FIGS. 5-7.

FIG. 9 is a fragmentary isometric view of the strap of FIGS. 5-7 with the strap supporting another releasable connector and a fishing net.

FIG. 10 is a fragmentary isometric view similar to FIG. 9 showing the releasable connector of the fishing net released from the utility strap.

### DESCRIPTION OF THE PREFERRED EMBODIMENT

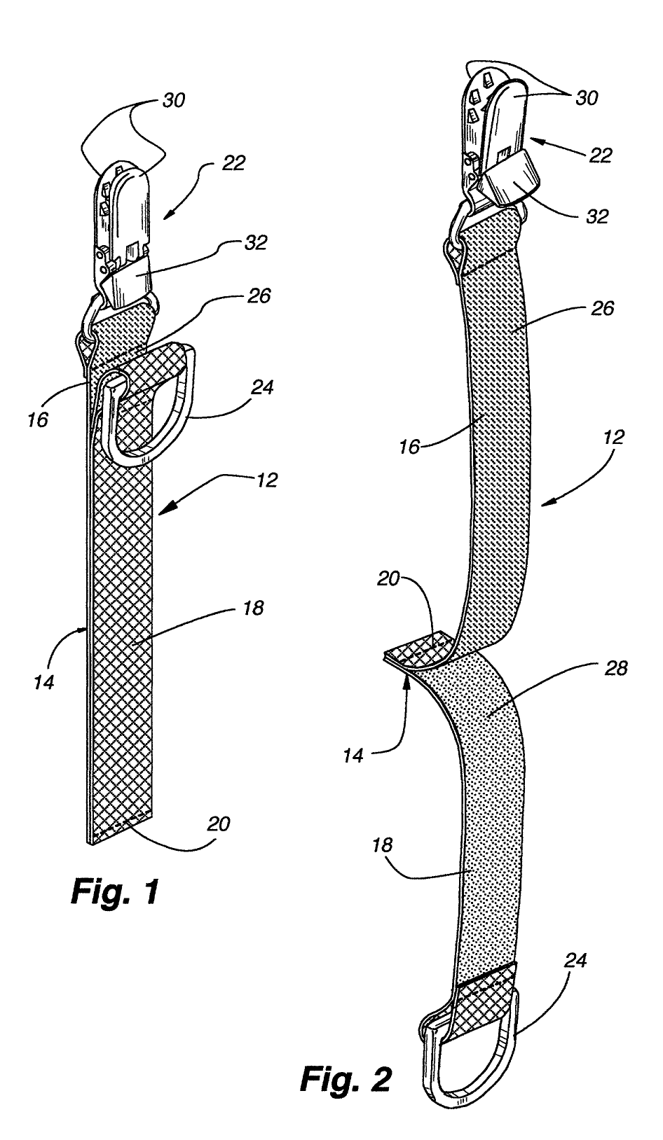

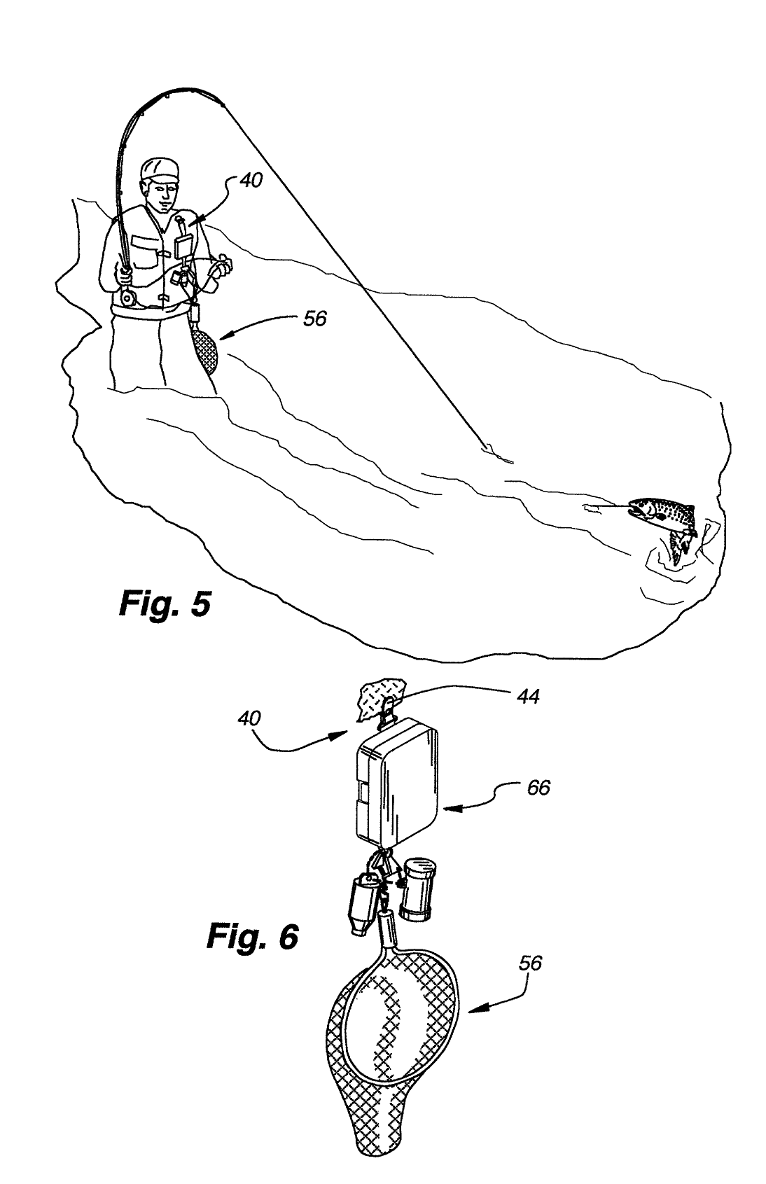

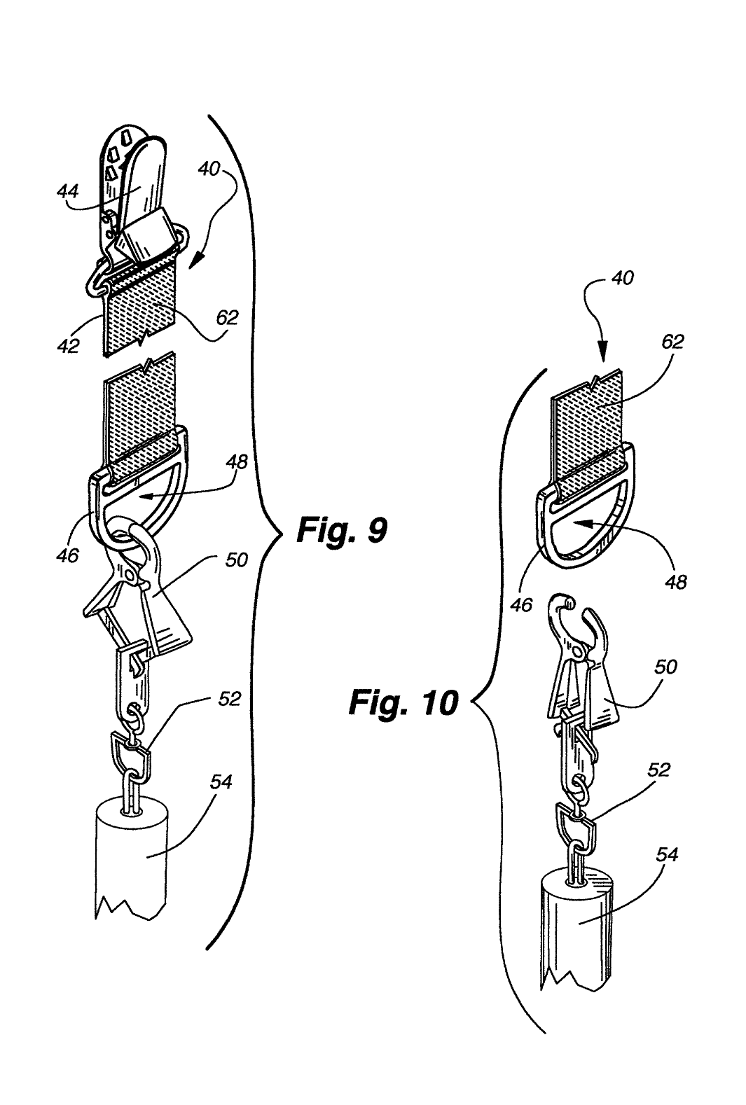

The fishing utility strap of the present invention is designed to be quickly, easily and releasably connected to any article of clothing worn by a fisherman and adapted to support various fishing accessories or items of equipment. The invention is disclosed in two embodiments with the first embodiment illustrated in FIGS. 1-4, and the second embodiment in FIGS. 5-10.

A first embodiment 12 of the utility strap of the present invention, as probably best seen in FIGS. 1 and 2, includes a strip 14 of material having two components 16 and 18 secured together along a line of joiner 20 at one end of the components. One of the components 16 has a quick-release alligator clip 22 at the opposite end and the other strip component 18 has a rigid loop 24 at its opposite end. One of the components 16 of the flexible strip material has one part 26 of a hook and loop type fastener on one face thereof and the other component 18 has the second part 28 of a hook and loop type fastener on a face thereof with the faces containing the hook and loop material being confronting so that they can be releasably connected in the closed position of FIG. 1 such that the alligator clip 22 is disposed adjacent to the rigid loop 24. When the hook and loop material is released, as in the open position of FIG. 2, the alligator clip and rigid loop are at opposite ends with the line of joiner 20 between the two components of material being at an intermediate location. The component parts of the strip of flexible material can be any relatively strong material such as nylon or the like and have the hook and loop type fastener material secured along one face of its entire length. For purposes of the present disclosure, a hook and loop type fastener material, such as is commonly marketed under the trademark Velcro® would be suitable and will be described as having two parts, a hook part and a loop part. As is well known in the art, the hook part is adapted to be releasably connected to the loop part when the parts are engaged in face-to-face relationship.

With reference to FIGS. 1 and 2, the alligator clip 22 is of a conventional type having a pair of locking jaws 30 that are pivotally connected together and releasably secured in a locked confronting relationship by a lock tab 32. The alligator clip is ideally suited for securing the utility strap 12 to an article of clothing 34 (FIG. 3) or the like at any location simply by inserting a portion of the article of clothing into the open jaws of the alligator clip and then securing or locking the clip in a closed position by pivoting the lock tab 32 downwardly (FIG. 1), which forces the locking jaws into a confronting relationship with the article of clothing releasably secured therebetween.

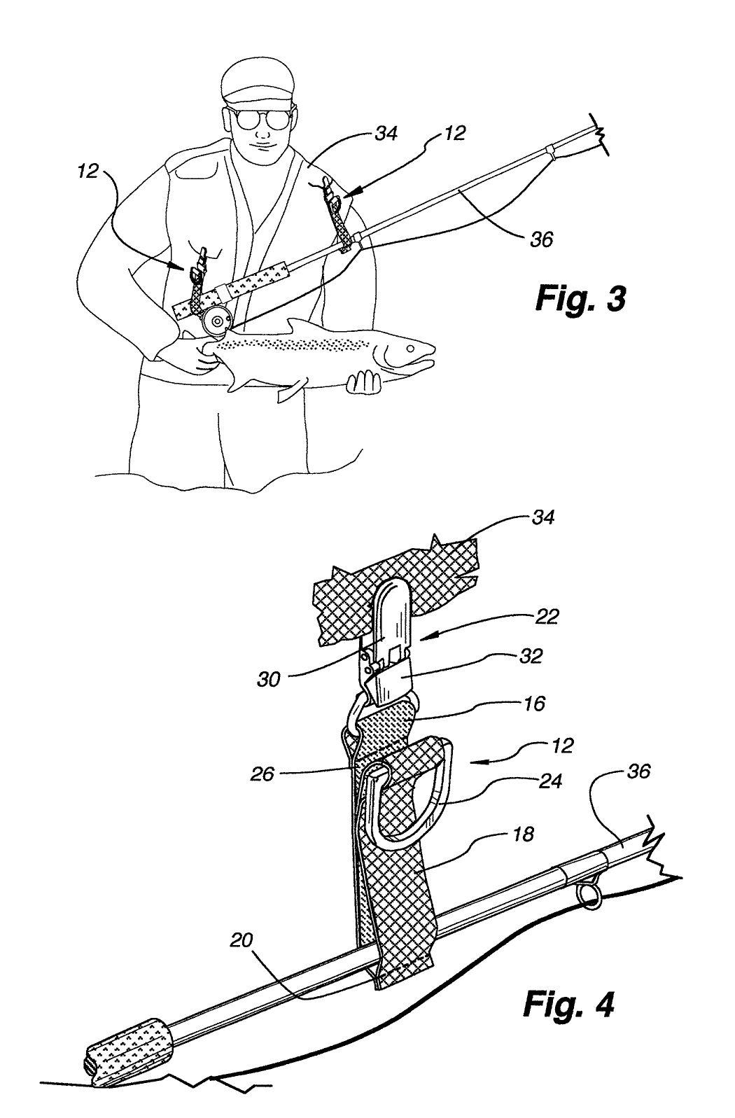

As mentioned, the alligator clip 22 is adapted to releasably secure the utility strap 12 to an article of clothing and the rigid loop 24 is adapted to support fishing accessories as will be described in more detail later. The components 16 and 18 of the strip 14 of material, however, can be selectively connected at any location along their length (FIG. 4) via the hook and loop material so that other fishing equipment or accessory items can be supported between the two components.

As illustrated in FIGS. 3 and 4, and by way of example, a fishing pole 36 can be supported by the strip 14 by passing a portion of the pole between the two components 16 and 18 of the strip and then securing the components together via the hook and loop fasteners around the fishing pole. By utilizing two of the utility straps 12 as illustrated in FIG. 3, a fishing person can suspend a fishing pole from his or her clothing in a hands-free manner so the hands can be used for other purposes or can simply be put in the user's pockets for example on a cold day.

It will be appreciated from the above that the utility strap 12, illustrated in FIGS. 1-4 not only includes a rigid loop 24 from which various items can be permanently or releasably suspended, but an additional system for positively confining fishing equipment or accessories by forming a closed loop around the equipment or accessories.

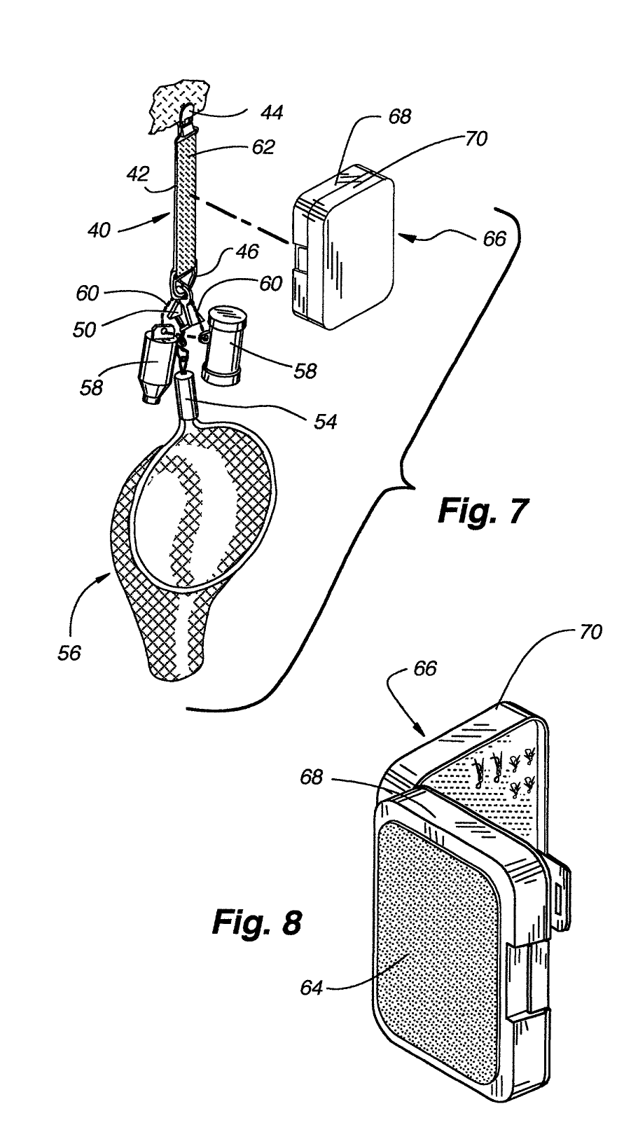

Looking next at FIGS. 5-10, and particularly at FIG. 7, a second embodiment 40 of the utility strap of the invention is shown. The utility strap 40 can be seen to include a strip 42 of flexible material having a quick-release alligator clip 44 secured at one end and a rigid loop 46 at the other end. The alligator clip and rigid loop could be identical or substantially identical to those used and described in connection with the first embodiment.

The rigid loop 46 is a conventional item, which can be made of plastic, metal, or the like, defines a relatively large semi-circular slot 48 in which items can be connected permanently or releasably to the strap 40.

In the illustrated use of the utility strap 40, a releasable clamp member 50 is connected to the rigid loop 46 and in turn supports a D-shaped ring 52 from which the handle 54 of a fishing net 56 is suspended. The releasable clamp member 50 can be easily removed from the rigid loop 46 so that a fisherman can independently use the fishing net or it simply can be suspended from the utility strap when not in use. Other fishing accessories 58 are shown in FIGS. 6 and 7 suspended from the rigid loop such as by releasable beaded chains 60 and by way of example, the other fishing accessories might be containers of float material commonly used by fisherman. Of course, any other accessory item could also be suspended from the rigid loop.

At least one face of the strip material 42 has one part 62 of a hook and loop type fastener material thereon and it is adapted to cooperate with the other part 64 of a hook and loop material which is secured to a fishing accessory that a fishing person may want to suspend from the utility strap. By way of example, one face of a box or container 66, such as of the type that might include fishing flies, lures, or the like, might have the other part of the hook and loop material thereon. In the disclosed embodiment, as probably best seen in FIG. 8, the container 66 has a base component 68 and a hingedly connected top 70, which are connected together with the base 68 having a sheet of the second part 64 of the hook and loop material secured thereto. The container can thereby be easily connected to or removed from the utility strap simply by applying a pulling force to the container which releases the two parts of the hook and loop material.

It will therefore be appreciated that the first and second embodiments of the utility strap of the present invention are readily adapted for supporting various types of fishing accessories or equipment in different ways.

Although the present invention has been described with a certain degree of particularity, it is understood that the present disclosure has been made by way of example, and changes in detail or structure may be made without departing from the spirit of the invention as defined in the appended claims.

I claim:

1. The combination of a utility strap and a piece of fishing equipment wherein said utility strap comprises:
an elongated flexible strip having at least one part of a hook and loop fastener extending along the length thereof and a quick-release connector secured to the strip, said quick-release connector being adapted to be releasably secured to an article of clothing and said at least one part of a hook and loop fastener being adapted to be releasably connected to said piece of fishing equipment.

2. The combination of claim 1 wherein both parts of said hook and loop fastener are positioned on said strip such that said strip can be releasably secured to itself to form a closed loop that releasably supports said piece of fishing equipment.

3. The combination of claim 1 wherein the other part of said hook and loop fastener is secured to said piece of fishing equipment and said piece of fishing equipment is releasably connected to said strap by said hook and loop fastener.

4. The combination of claim 1 wherein said quick-release connector is secured to one end of said strip.

5. The combination of claim 4 further including a rigid loop secured to the other end of said strip.

6. The combination of claim 1 wherein said quick-release connector is an alligator clip.

7. The combination of claim 2 wherein one part of said hook and loop fastener extends approximately halfway along the length of said strip and the other part extends along approximately the other half of the length of said strip.

8. The combination of claim 3 wherein said piece of fishing equipment is a box for confining fishing related accessories.

9. The combination of claim 2 wherein said piece of fishing equipment is a fishing pole.

10. The combination of claim 9 further including a second utility strap substantially the same as said first-mentioned utility strap.

11. The combination of claim 2 wherein said strip is formed from two components that are secured together at corresponding ends thereof with one of said strip components having one part of said hook and loop fastener and the other of said strip components having the other part of said hook and loop fastener.
